(19) United States
(12) Patent Application Publication
(10) Pub. No.: US 2023/0118514 A1
(43) Pub. Date: Apr. 20, 2023

(54) SECURITY DEVICE TO PROTECT UNUSED COMMUNICATION PORTS

(71) Applicant: Schweitzer Engineering Laboratories, Inc., Pullman, WA (US)

(72) Inventor: Mark L. Zeller, Clarkston, WA (US)

(73) Assignee: Schweitzer Engineering Laboratories, Inc., Pullman, WA (US)

(21) Appl. No.: 17/502,328

(22) Filed: Oct. 15, 2021

(51) Int. Cl. G06F 21/55; G06F 21/86; G06F 21/60; G06F 21/73; G06F 11/30

(52) U.S. Cl. CPC G06F 21/552; G06F 21/86; G06F 21/606; G06F 21/73; G06F 11/3093

(57) ABSTRACT

The present disclosure pertains to systems and methods to monitor communication ports. In one embodiment, a system may include a host device that generates a first flow of traffic to send via a host device communication port. A security dongle may receive the first flow of traffic via a security dongle communication port in communication with the host device communication port. The security dongle may generate a second flow of traffic. The security dongle may transmit the second flow of traffic through the security dongle communication port. The host device may receive the second flow of traffic from the host device communication port and may generate an alarm when the second flow of traffic deviates from an expected response. The communication between the host device and the security dongle allows the host device to detect when the security dongle is disconnected from the host device.

### TECHNICAL FIELD

The present disclosure pertains to security devices to secure communication ports. More particularly, but not exclusively, the systems and methods disclosed herein may be used in electric power systems to protect again unauthorized access by monitoring communication ports that are unused, along with ports that are in use.

### BRIEF DESCRIPTION OF THE DRAWINGS

Non-limiting and non-exhaustive embodiments of the disclosure are described, including various embodiments of the disclosure with reference to the figures, in which:

FIG. 1 illustrates an intelligent electronic device (IED) including a plurality of ports into which a security dongle consistent with embodiments of the present disclosure may be plugged.

FIG. 2 illustrates a functional block diagram of an IED and a security dongle consistent with embodiments of the present disclosure.

FIG. 3 illustrates a flowchart of a method of monitoring a communication port using a security dongle consistent with embodiments of the present disclosure.

FIG. 4 illustrates a block functional block diagram of a security device operable with an active communication port consistent with embodiments of the present disclosure.

### DETAILED DESCRIPTION

Communication ports may allow an individual with physical access to a device to interact with the device by connecting to one or more of the unused ports and/or tapping into an active port. Using such a connection, an attacker may gain access to sensitive information and/or damage or disable equipment. Such a threat is particularly acute in the context of critical infrastructure, such as electric power systems.

The potential security concerns related to unused communication ports prompted the North American Electric Reliability Corporation (“NERC”) to enter a standard requiring electric system operators to secure unused physical ports. Many schemes to secure unused communication ports rely on physically blocking the ports; however, if the intruder defeats the physical device the port may be left vulnerable. To address this requirement, some operators have filled unused ports with epoxy or other types of material. Such efforts to disable unused communication ports may be irreversible and may have unintended or adverse consequences beyond disabling the unused communication ports.

Similarly, an individual with physical access to a device may connect to active communication ports and disrupt the operation of a system. For example, an attacker may insert a device that allows the attacker to monitor and/or transmit using an active communication channel. The attacker may gain access to sensitive information by monitoring the channel and/or interfere with the operation of the system.

The inventor of the present disclosure has recognized that various advantages may be realized by connecting a security dongle to unused communication ports. A security dongle consistent with the present disclosure may communicate with another device to ensure that the security dongle remains attached to a communication port. If communication between the device and the security dongle is interrupted, various actions may be implemented, such as triggering an alarm, disabling the port, blocking changes to the IED, or implementing other types of protective actions. Security dongles consistent with the present disclosure may provide a simple and cost-effective way to continuously monitor and secure unused communication ports. Further, security dongles consistent with the present disclosure may allow such ports to remain functional for future use. Security dongles consistent with the present disclosure may also provide dust and dirt protection and provide a visual indication that a port is not in use.

Further, the inventor of the present disclosure has recognized advantages associated with monitoring active communication ports using a security device consistent with the present disclosure. A security device used with an active port may monitor the connection between two devices and trigger an alarm if a disruption is detected (e.g., the cable is unplugged) or if other suspicious activity is detected.

As used herein, an IED may refer to any microprocessor-based device that monitors, controls, automates, and/or protects monitored equipment within a system. Such devices may include, for example, differential relays, distance relays, directional relays, feeder relays, overcurrent relays, voltage regulator controls, voltage relays, breaker failure relays, generator relays, motor relays, remote terminal units, automation controllers, bay controllers, meters, recloser controls, communication processors, computing platforms, programmable logic controllers (PLCs), programmable automation controllers, input and output modules, and the like. The term IED may be used to describe an individual IED or a system comprising multiple IEDs. Further, IEDs may include sensors (e.g., voltage transformers, current transformers, contact sensors, status sensors, light sensors, tension sensors, etc.) that provide information about the electric power system.

The embodiments of the disclosure will be best understood by reference to the drawings. It will be readily understood that the components of the disclosed embodiments, as generally described and illustrated in the figures herein, could be arranged and designed in a wide variety of different configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order, or even sequentially, nor do the steps need to be executed only once, unless otherwise specified.

In some cases, well-known features, structures, or operations are not shown or described in detail. Furthermore, the described features, structures, or operations may be combined in any suitable manner in one or more embodiments. It will also be readily understood that the components of the embodiments, as generally described and illustrated in the figures herein, could be arranged and designed in a wide variety of different configurations. For example, throughout this specification, any reference to “one embodiment,” “an embodiment,” or “the embodiment” means that a particular feature, structure, or characteristic described in connection with that embodiment is included in at least one embodiment. Thus, the quoted phrases, or variations thereof, as recited throughout this specification are not necessarily all referring to the same embodiment.

Several aspects of the embodiments disclosed herein may be implemented as software modules or components. As used herein, a software module or component may include any type of computer instruction or computer-executable code located within a memory device that is operable in conjunction with appropriate hardware to implement the programmed instructions. A software module or component may, for instance, comprise one or more physical or logical blocks of computer instructions, which may be organized as a routine, program, object, component, data structure, etc., that performs one or more tasks or implements particular abstract data types.

In certain embodiments, a particular software module or component may comprise disparate instructions stored in different locations of a memory device, which together implement the described functionality of the module. A module or component may comprise a single instruction or many instructions and may be distributed over several different code segments, among different programs, and across several memory devices. Some embodiments may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Embodiments may be provided as a computer program product including a non-transitory machine-readable medium having stored thereon instructions that may be used to program a computer or other electronic device to perform processes described herein. The non-transitory machine-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable media suitable for storing electronic instructions. In some embodiments, the computer or another electronic device may include a processing device such as a microprocessor, microcontroller, logic circuitry, or the like.

The processing device may further include one or more special-purpose processing devices such as an application-specific interface circuit (ASIC), PAL, PLA, PLD, field-programmable gate array (FPGA), or any other customizable or programmable device.

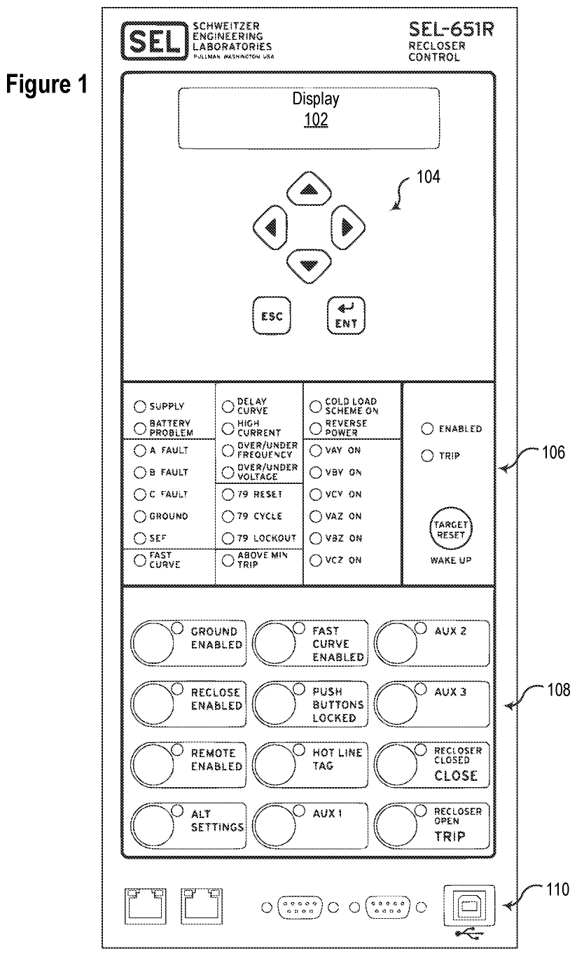

FIG. 1 illustrates a representation of a system 100 comprising a plurality of communication ports 110 of various types that may be monitored by security dongles consistent with the present disclosure. The illustrated system comprises a recloser control, model SEL-651R available from Schweitzer Engineering Laboratories of Pullman, Washington; however, the same principles may be applied to a wide range of devices that include communication ports of various types. System 100 includes display 102 to provide information and a plurality of buttons 104 that allow a user to navigate information on the display 102. A plurality of indicators 106 may provide information about various conditions monitored by system 100. A plurality of functions 108 may be used to invoke various functions and settings.

A plurality of communication ports 110 may be used to interface with a variety of devices. In the illustrated embodiment, system 100 includes two serial ports two Ethernet ports, and a USB port. The serial ports may be used for a variety of functions, such as communicating with other devices, retrieving events, adjusting settings, updating firmware, and performing other functions. For example, a communication port may receive a common time signal from a Global Navigational Satellite System (GNSS) (e.g., the Global Positioning System (GPS)) or may communicate with a piece of monitored equipment (e.g., a recloser) in an electric power system.

A security dongle (not shown) may be connected to one or more communication ports 110 of system 100 that are not typically in use. In some embodiments, system 100 may generate and send a stream of communications to the security dongle, and the security dongle may generate responses to such communications. The exchange of communication allows system 100 to confirm that the security dongles remain in place and to confirm that no unauthorized devices are connected to any of the plurality of communication ports 110. Further, system 100 may detect whether a device has been disconnected.

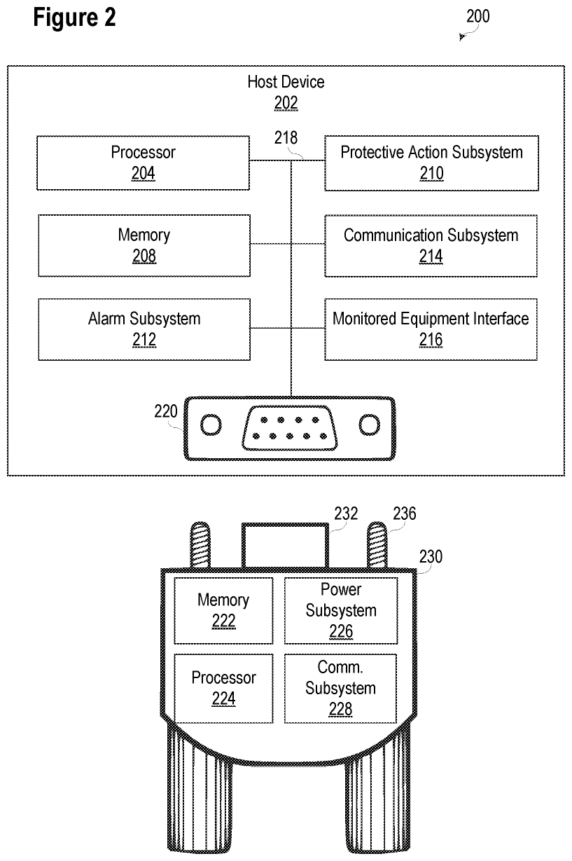

FIG. 2 illustrates a functional block diagram of a system 200 comprising an IED with a communication port 220 and a security dongle 230 consistent with embodiments of the present disclosure. System 200 may be implemented using hardware, software, firmware, and/or any combination thereof. In some embodiments, system 200 comprises an IED, while in other embodiments, certain components or functions described herein may be associated with other devices or performed by other devices. In the illustrated embodiment, security dongle 230 connects to a serial port, but in other embodiments, a security dongle may be configured to connect to a variety of other types of communication ports. The specifically illustrated configuration is merely representative of one embodiment consistent with the present disclosure. A connector 232 disposed on the security dongle 230 may couple the security dongle 230 to the host device 202.

A processor 204 executes instructions stored in a memory 208 and/or received via communication subsystem 214, a monitored equipment interface 216, and the other subsystems and components in host device 202. Processor 204 may operate using any number of processing rates and architectures. Processor 204 may perform various algorithms and calculations described herein. Processor 204 may be embodied as a general-purpose integrated circuit, an application-specific integrated circuit, a field-programmable gate array, and/or any other suitable programmable logic device. Processor 204 may communicate with other elements in system 204 by way of a bus 218. Processor 224 in security dongle 230 may perform a similar function to processor 204.

Memory 208 may be embodied as any of a variety of transitory and non-transitory computer-readable storage media. Memory 208may comprise executable instructions to perform processes or methods described herein. Memory 208 may comprise volatile and non-volatile machine-readable media such as, but not limited to, hard drives, removable media, optical disks, CD-ROMs, DVD-ROMs, ROMs, RAMs, EPROMs, EEPROMs, magnetic or optical cards, solid-state memory devices, or other types of media/machine-readable media suitable for storing electronic instructions or other types of electronic information. Memory 222 in security dongle 230 may perform a similar function to memory 208.

A monitored equipment interface 216 may receive status information from, and issue control instructions to, a piece of monitored equipment (e.g., a generator, transformer, circuit breaker, or the like). Monitored equipment interface 216 may implement control actions upon the detection of various conditions. Such instructions may include, for example, opening a breaker, adjusting a parameter of a generator, changing a tap of a transformer.

A protective action subsystem 210 may implement a protective action based on various conditions monitored by host device 202. For example, a protective action may be implemented by the identification of a fault in an electric power system or by the unauthorized removal of a security dongle 230 from communication port 220. Upon removal of security dongle 230 from communication port 220, protective actions may include blocking communication to or from port 220, disabling port 220, preventing changes to settings associated with host device 202, etc. Further, protective action subsystem 210 may also implement protective action to monitored equipment. Such protective actions include tripping a breaker, selectively isolating a portion of the electric power system, etc.

An alarm subsystem 212 may generate an alarm based upon various conditions. For example, an alarm may be generated based on the interruption of a flow of traffic between host device 202 and security dongle 230. Further, an alarm may be generated based on conditions associated with an electric power system monitored or automated by host device 202. Alarm subsystem 212 may generate and/or transmit an alarm in various ways, including transmission to another device, an email message, an SMS message, or another type of communication to alert an operator of the alarm.

Communication subsystem 214 may be configured to communicate with devices and/or IEDs, including security dongle 230. In certain embodiments, communication subsystem 214 may facilitate direct communication with other IEDs or communicate with systems over a communications network. Communication subsystem 214 may perform negotiations with other devices to establish communication and format messages to comply with various communication protocols. Measurements relating to electrical conditions and other information used by system host device 202 may be transmitted via communication subsystem 214. Further, measurements and information created by host device 202 may be transmitted via communication subsystem 214 to other components, including communication port 220.

Communication subsystem 214 may also generate a flow of traffic sent to and process communications received from security dongle 230. In one embodiment, the flow of traffic may be a simple message that is regularly repeated, and the security dongle 230 may simply retransmit the same message. In other embodiments, more complex exchanges may occur. For example, a message count or coded message may be included in the traffic stream produced by communication subsystem 214, and the responses from security dongle 230 may be verified against an expected result before being accepted. In some embodiments, the stream of data exchanged between host device 202 and security dongle 230 may be encrypted.

A communication subsystem 228 in security dongle 230 may generate a stream of traffic in response to messages received from host device 202. In one embodiment, security dongle 230 simply retransmits the messages received from host device 202 after a delay. In this embodiment, memory 222 may act as a buffer that stores the message for a specified duration. This embodiment may provide a simple implementation because the message from the security dongle 230 is a delayed representation of the message received from the host device 202.

In other embodiments where the exchange is more complex, processor 224 may generate a response based on instructions stored in memory 222. In one embodiment, communication subsystem 228 may include an identifier associated with security dongle 230 that allows host device 202 to identify a particular security dongle. The identifier may allow the host device 202 to determine whether a security dongle has been moved from one communication port to another. Further, the identifier may allow a host device to determine whether a particular security dongle is active when multiple security dongles are in use.

In some embodiments, communication subsystem 228 may further comprise a wireless transmission system that allows security dongle 230 to communicate information wirelessly. Wireless communication may allow security dongle 230 to communicate information to devices other than host device 202. For example, a plurality of security dongles in a substation may each include a Bluetooth or 802.11 interface that transmits information to a security hub. Information from the plurality of devices may allow for a coordinated response across multiple devices.

A power subsystem 226 may provide power to security dongle 230. In various embodiments, power may be drawn from communication port 220. Powering security dongle 230 from communication port 220 avoids the need for an external power supply and may simplify implementation. In one specific embodiment, power subsystem 226 may draw power from communication port 220 based on the disclosure of U.S. Patent No. 7,034,604, titled Communications Device Powered from Host Apparatus, and which is incorporated herein by reference.

A connector 232 may couple security dongle 230 to communication port 220. Connector 232 comprises a physical interface that physically couples security dongle 230 to communication port 220 and provides electrical connectivity via pins or wires. In the illustrated embodiment, screws 234 and 236 may be used to physically secure security dongle 230 to communication port 220. In some embodiments, the physical connection between communication port 220 and security dongle 230 may include a secured fastener. In one specific embodiment, screws 234 and 236 may include heads with a unique or uncommon pattern to impede the removal of the security dongle 230. In other embodiments, a lock or other type of fastener may impede the removal of the security dongle 230 from communication port 220. Further, the electronics of security dongle 230 may be protected from physical attack in various ways, such as encasing the electronics in an epoxy resin.

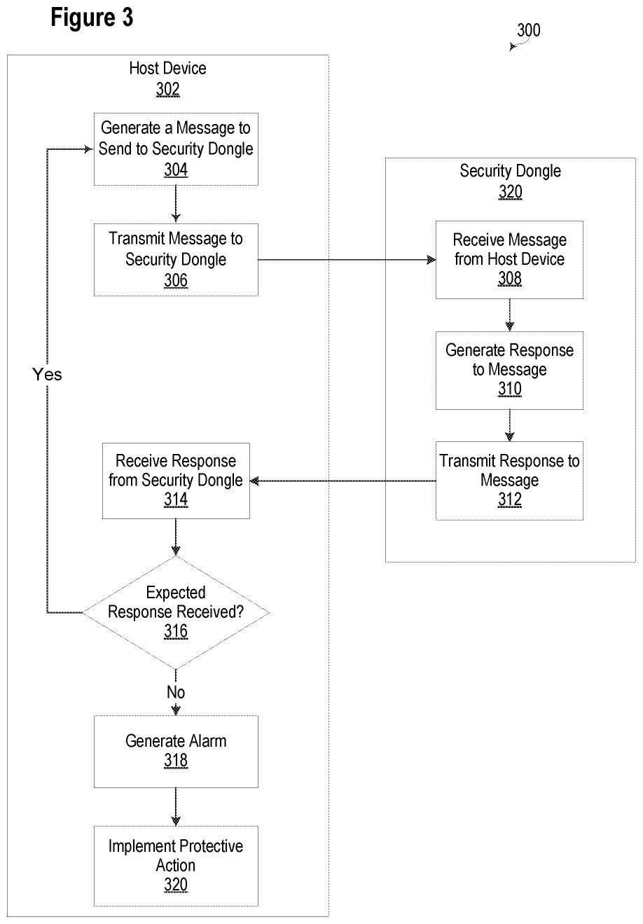

FIG. 3 illustrates a flowchart of a method 300 of monitoring a communication port using a security dongle 320 consistent with embodiments of the present disclosure. At 304, a host device 302 may generate a message to send to the security dongle 320. A variety of types of messages of varying complexity may be generated. For example, the messages may range from a simple message (e.g., a fixed pattern of bits) to a complex message. At 306, the host device 302 may transmit the message to the security dongle 320. The message may be transmitted from host device 302 to the security dongle 320 through a communication port monitored by the security dongle 320. In various embodiments, the communication port may comprise a serial port, an Ethernet port, a USB port, or another type of port.

At 308, the security dongle 320 may receive the message from the host device 302. The security dongle 320 may generate a response to the message at 310. Depending on the embodiment, the response may comprise a simple message or a complex message. In one specific embodiment, the response may be a delayed representation of the received message. Further, in various embodiments, the exchange between the host device 302 and the security dongle 320 may be encrypted. The security dongle 320 transmits the response to the message at 312.

At 314, host device 302 may receive a response from security dongle 320 through the communication interface. The host device 302 may compare the received response to an expected response at 316. If the received message matches the expected response, the host device may return to 304. If the message does not match the expected response, host device 302 may generate an alarm at 318. The alarm may comprise an email message, an SMS message, or another type of communication to alert an operator of the alarm. The host device 302 may implement a protective action at 320 based on the alarm. In various embodiments, the protective action may comprise disabling the host device 302, disabling the communication port, or taking other actions.

In some embodiments, unused wires in a communication path could be used to monitor an active communication link and/or to ensure a constant communication stream between two devices. A variety of commonly used cables include unused conductors. For example, USB to EIA-232 cables use only four conductors, leaving 5 unused conductors that may be used to provide a communication path between two security dongles. In such embodiments, there may not be a need for an IED or other type of host device to generate traffic. The constant communication between the two security dongles may validate an uninterrupted wired connection between the devices. The ongoing exchange between the two security dongles may make it more difficult for an external device to intercept and decipher the primary communication stream because the external device may not differentiate between the primary communication stream and the traffic between the security dongles. Such embodiments may be used for ports that are either in use or not used, by establishing transmit and receive function inside each security dongle that is independent of the IED. If the security dongle is powered by the IED port, any interruption of the power (e.g., unplugging the security dongle) may generate a protective action (e.g., triggering an alarm, disabling the port, blocking changes to the IED, etc.).

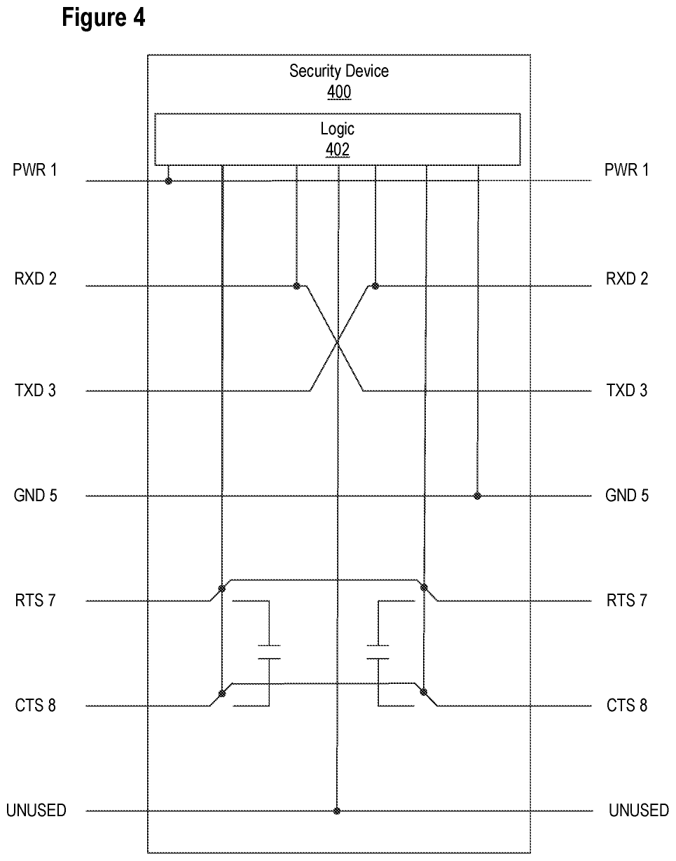

FIG. 4 illustrates a block functional block diagram of a security device 400 operable with an active communication port consistent with embodiments of the present disclosure. Security device 400 is specifically adapted for use with an RS-232 cable, however, similar principles may be used to adapt security device 400 to a variety other types of cables. More specifically, but not exclusively, security devices may be created for USB or Ethernet cables using the principles described herein.

Security device 400 includes a plurality of inputs and outputs. The specific types of inputs and outputs may be determined by the type of cable for which security device 400 is intended for use. In the illustrated embodiment, the inputs and outputs include a power connection (PWR 1), a receive connection (RXD 2), a transmit connection (TXD 3), a ground connection (GND 5), a request to send (RTS 7) connection, a clear to send (CTS 8) connection. In some embodiments one or more unused connections may also be present, but unused connections are not required.

Security device 400 may typically operate transparently to end devices connected to the inputs and outputs. During typical operation, logic 402 may monitor signals on the inputs and outputs to ensure that the communication channel remains uncompromised. A variety of monitoring techniques may be used. For example, the power connection may be monitored. When a cable is disconnected from a communication port, the power connection may be interrupted. This interruption may trigger an alert so that an operator may determine whether the interruption is expected (e.g., associated with maintenance or reconfiguration) or is unauthorized. In some embodiments, security device 400 may also be powered from electrical energy collected from the power connection.

Logic 402 may also monitor the transmit and receive connections for a continuous flow of information. If the flow of information is interrupted, it may be an indication that the communication channel has been comprised, and an alert may be generated. In response to the alert, an operator may determine whether the interruption is expected or is associated with unauthorized activity.

In response to unauthorized activity, security device 400 may block additional communication using the request to send and/or clear to send channels. In response to unauthorized activity or anomalous conditions, logic 402 may connect these channels to capacitors using switches. Such a connection with disable communication using the receive and transmit channels. Security device 400 may be configured to receive a signal to re-enable communication. In one specific embodiment, the signal to re-enable communication may be transmitted using an unused communication channel. In another specific embodiment, security device 400 may be IP addressable and may receive the signal to re-eneable communication through IP communications with

If unused channels are available, logic 402 may transmit a periodic signal that is received by devices (e.g., IEDs in an electric power system) connected to the inputs and outputs of security device 400. The connected devices may monitor for an interruption of the periodic signal, and if the periodic signal is interrupted, may suspend communication.

While specific embodiments and applications of the disclosure have been illustrated and described, it is to be understood that the disclosure is not limited to the precise configurations and components disclosed herein. Accordingly, many changes may be made to the details of the above-described embodiments without departing from the underlying principles of this disclosure. The scope of the present invention should, therefore, be determined only by the following claims.

What is claimed is:

1. A system, comprising:
a host device, comprising:
a host device processor;
a host device communication port in communication with the host device processor; and
a host device non-transitory computer-readable storage medium in communication with the host device processor and comprising instructions that when executed cause the host device processor to:
generate a first flow of traffic to send to the host device communication port;
receive a second flow of traffic from the host device communication port; and
generate an alarm when the second flow of traffic deviates from an expected response; and
a security dongle, comprising:
a security dongle communication port to couple the security dongle to the host device communication port;
a security dongle processor; and
a security dongle non-transitory computer-readable storage medium in communication with the security dongle processor and comprising instructions that when executed cause the security dongle processor to:
receive the first flow of traffic;
generate the second flow of traffic based on the first flow of traffic; and
transmit the second flow of traffic through the security dongle communication port.

2. The system of claim 1, wherein the security dongle further comprises a power subsystem to draw power from the host device and to provide power to the security dongle.

3. The system of claim 1, wherein the host device comprises an intelligent electronic device in an electric power system.

4. The system of claim 1, wherein the host device communication port comprises one of a serial port, an Ethernet port, and a USB port.

5. The system of claim 1, wherein the host device non-transitory computer-readable storage medium further comprises instructions that when executed cause the host device processor to implement a protective action based on the alarm.

6. The system of claim 5, wherein the protective action comprises disabling the host device.

7. The system of claim 1, wherein the security dongle further comprises a wireless communication subsystem to transmit a signal to a wirelessly connected device.

8. The system of claim 1, wherein the second flow of traffic comprises an identifier associated with the security dongle.

9. The system of claim 1, wherein the security dongle further comprises a secured fastener to impede disconnection of the security dongle from the host device.

10. The system of claim 1, wherein the second flow of traffic comprises a delayed representation of the first flow of traffic.

11. A method, comprising:
generating, using a host device, a first flow of traffic to send to a security dongle;
transmitting, using the host device, the first flow of traffic to the security dongle through a host device communication port;
receiving, using the security dongle, the first flow of traffic from the host device through a security dongle communication port;
generating, using the security dongle, a second flow of traffic based on the first flow of traffic;
transmitting, using the security dongle, the second flow of traffic to the host device through the security dongle communication port;
receiving, using the host device, the second flow of traffic through the host device communication port;
determining, using the host device, that the second flow of traffic deviates from an expected response; and
generating, using the host device, an alarm.

12. The method of claim 11, further comprising powering the security dongle using power drawn from the host device.

13. The method of claim 11, wherein the host device comprises an intelligent electronic device in an electric power system.

14. The method of claim 11, wherein the host device communication port comprises one of a serial port, an Ethernet port, and a USB port.

15. The method of claim 11,further comprising implementing, using the host device, a protective action based on the alarm.

16. The method of claim 15, wherein the protective action comprises disabling the host device.

17. The method of claim 11, further comprising transmitting, using the security dongle, a signal to a wirelessly connected device using a wireless communication subsystem.

18. The method of claim 11, wherein the second flow of traffic comprises an identifier associated with the security dongle.

19. The method of claim 11, further comprising providing a secured fastener associated with the security dongle to impede disconnection of the security dongle from the host device.

20. The method of claim 11, wherein the second flow of traffic comprises a delayed representation of the first flow of traffic.
